(19) United States
(12) Patent Application Publication
(10) Pub. No.: US 2010/0206799 A1
(43) Pub. Date: Aug. 19, 2010

(54) Liquid Filter

(75) Inventors: David Leavitt, Edmond, OK (US); John Famula, Severna Park, MD (US); Christer Broman, Millersville, MD (US); Jeremy Hess, Fayetteville, AR (US)

Correspondence Address: DUNLAP CODDING, P.C., PO BOX 16370, OKLAHOMA CITY, OK, 73113, US

(73) Assignee: FLUID TREATMENTS SYSTEMS, INC.

(21) Appl. No.: 12/372,149

(22) Filed: Feb. 17, 2009

(51) Int. Cl. B01D 29/52

(52) U.S. Cl. 210/314

(57) ABSTRACT

The fluid treatment system of the present invention includes a liquid filtering method and apparatus. Generally, the liquid filtering apparatus has a housing with at least one inlet, at least one outlet, and an internal chamber extending therebetween such that the at least one inlet and the at least one outlet are in fluid communication with the internal chamber of the housing. The liquid filtering apparatus also has a first filter disposed in the internal chamber of the housing in proximity to the at least one inlet, the first filter capable of removing particulate matter from a liquid entering the internal chamber of the housing via the inlet thereof; and a second filter disposed in the internal chamber of the housing in proximity to the at least one outlet, the second filter capable of removing dissolved impurities from the liquid entering the internal chamber of the housing via the Inlet thereof. Generally, the liquid filtering method includes the steps of providing the filtering apparatus described above, connecting the filtering apparatus to a liquid dispensing source and passing a liquid through the filtering apparatus such that the liquid passes through the at least one inlet into the internal chamber of the housing, through the first filter, through the second filter and out the at least one outlet.

### CROSS-REFERENCE TO RELATED APPLICATIONS

Not applicable.

### FIELD OF THE INVENTION

The present invention relates generally to fluid treatment systems and more particularly, but not by way of limitation, to a liquid filtering apparatus and liquid filtering method.

### BACKGROUND OF THE INVENTION

Fluid treatment systems, devices and processes are necessary for purifying fluids such as water, air, gases and oil. Purified water is essential for human health and recreation, and for countless agricultural, industrial, military and medical applications. Polluted air and contaminated exhaust from combustion processes and effluent from chemical production can be harmful and must be treated to remove contaminants prior to release into the environment. Purification typically involves the removal or destruction or neutralization of harmful and undesirable biological and chemical substances present in water, air and other fluids.

Fluid treatment processes include filtration, chemical disinfection, oxidation and reduction, adsorption, electrochemical separation and neutralization. Contaminants are often removed from air and other gases by filtration, catalyzed destruction and/or adsorption onto a suitable media such as activated carbon. Water is commonly treated to remove micro-organisms, such as bacteria or algae, and harmful metal ions, such as mercury and lead. Potable water is prepared by filtration and chemical coagulation to remove solids and particulate matter followed by chemical disinfection to destroy pathogens. Water used in swimming pools and spas is also purified by filtration and chemical treatment. Chemicals such as chlorine, bromine, copper or silver ions are commonly used to disinfect and purify water. When used to purify water in swimming pools, spas and hot tubs chlorinated and brominated compounds are dangerous to the environment and can cause human health problems, including asthma in children and birth defects in pregnant women.

Metal particulates are also used for water treatment and/or additional treatment processes. Metal particulates are less hazardous to human health and less damaging to the environment than chlorine and bromine treatment. Metal particulates made from copper and zinc alloys have been used for many years to treat water containing bacteria and algae. U.S. Pat. No. 5,314,623 discloses a method for treating fluids that utilizes a bed of metal particles such as aluminum, steel, zinc, tin, copper, and mixtures and alloys thereof. Especially desirable results have been obtained where the metal particles are zinc and copper particles, which can be alloyed to form brass having the capability of undergoing oxidation/reduction reactions when exposed to water and other polar fluids that are useful in removing heavy metals from the fluids. Brass particulates can be used to catalytically destroy chlorine present in water and to selectively remove lead and mercury. Copper/zinc alloys containing other constituents, such as silver, are also reported to be effective bacteriostatic agents, and can be used to control bacteria in both air and water.

Metal particles have been used to form packed beds of particles enclosed within a treatment device to provide suitable surface area and contact time for removal of the contaminants from a fluid. Because the metal particles are reactive, particles within the packed beds fuse together in the presence of the fluid or decompose to form fines that clog the bed and reduce porosity, resulting in a reduction of treatment efficiency and excessively high pressure drops through the bed or column of particles.

The prior art also describes the use of copper/zinc alloys in the form of a metal reticulated foam media to provide effective fluid treatment without the need for a packed bed of metal particulates. The metal reticulated foam media preferably are of the type described in U.S. Pat. No. 5,552,058, entitled “Cooling Tower Water Treatment Method” issued Sep. 3, 1996; U.S. Pat. No. 5,599,457 entitled “Machine Coolant Treatment Method” issued Feb. 4, 1997; U.S. Pat. No. 5,622,627 entitled “Parts Washer System” issued Apr. 22, 1997; U.S. Pat. No. 5,599,456 entitled “Fluid Treatment Utilizing a Reticulated Foam Structured Media Consisting of Metal Particles” issued Feb. 4, 1997; and U.S. Patent Application No. 2006/0182944 entitled “Flexible Reticulated Foam Fluid Treatment Media and Method of Preparation” filed Feb. 10, 2006 and published Aug. 17, 2006, the disclosures of each of which are hereby expressly incorporated herein by reference.

The metal reticulated foam media shown in the above-referenced patents and patent application provides a high surface area for fluid treatment and a low pressure drop, allowing high flow rates and low restriction that facilitate oxidation/reduction reactions between the contaminants in the fluid and the metal reticulated foam media. Fluid treatment systems utilizing such metal reticulated foam media substantially remove and/or reduce the amount of contaminates, such as chlorine, dissolved heavy metal ions (including but not limited to arsenic, cadmium, chromium VI, chromium III, selenium, and mercury), sulfur, iron and the like from a fluid. The metal reticulated foam media can also be used to control the growth of microorganisms, such as bacteria, algae and fungus, and to remove scale and minimize scale formation from the surfaces of conduits, pipes and ducts in contact with the treated fluid. Metal reticulated foam media can also contain silver and/or other metals. As shown in U.S. Pat. No. 6,395,168, a copper-zinc metal reticulated foam media is disclosed that contains silver to enhance the disinfection capability of the metal reticulated foam media.

### BRIEF DESCRIPTION OF THE DRAWINGS

FIG. 1 is a pictorial representation of the filtering apparatus of the present invention connected to a liquid dispensing source.

FIG. 2 is a pictorial representation of the filtering apparatus of the present invention.

FIG. 3 is a cross-sectional pictorial representation of the filtering apparatus of the present invention depicting the upper portion of the housing of the filtering apparatus separated from the lower portion of the housing of the filtering apparatus.

FIG. 4 is a cross-sectional pictorial representation of the filtering apparatus of the present invention.

FIG. 5 is a pictorial representation of the filtering apparatus of the present invention depicting the upper portion of the housing of the filtering apparatus separated from the lower portion of the housing of the filtering apparatus.

FIG. 6 is a pictorial representation of the filtering apparatus of the present invention depicting the upper portion of the housing of the filtering apparatus separated from the first filter, the second filter and the lower portion of the housing of the filtering apparatus.

### DETAILED DESCRIPTION OF THE INVENTION

Generally, the fluid treatment system of the present invention includes a liquid filtering apparatus having a housing with at least one inlet, at least one outlet, and an internal chamber extending therebetween such that the at least one inlet and the at least one outlet are in fluid communication via the internal chamber of the housing. The liquid filtering apparatus also includes a first filter disposed in the internal chamber of the housing in proximity to the at least one inlet, the first filter capable of removing particulate matter from a liquid entering the internal chamber of the housing via the inlet thereof; and a second filter disposed in the internal chamber of the housing in proximity to the at least one outlet, the second filter capable of removing dissolved impurities from the liquid entering the internal chamber of the housing via the inlet thereof.

Generally, the fluid treatment system of the present invention also includes a method for filtering a liquid, the method including the steps of providing a filtering apparatus which includes a housing having at least one inlet, at least one outlet, and an internal chamber extending therebetween such that the at least one inlet and the at least one outlet are in fluid communication via the internal chamber of the housing; a first filter disposed in the internal chamber of the housing in proximity to the at least one inlet, the first filter capable of removing particulate matter from a liquid entering the internal chamber of the housing via the inlet thereof; a second filter disposed in the internal chamber of the housing in proximity to the at least one outlet, the second filter capable of removing dissolved impurities from the liquid entering the internal chamber of the housing via the inlet thereof; connecting the filtering apparatus to a liquid dispensing source; and passing a liquid through the filtering apparatus so that the liquid passes through the at least one inlet into the internal chamber of the housing, through the first filter, through the second filter and out the at least one outlet.

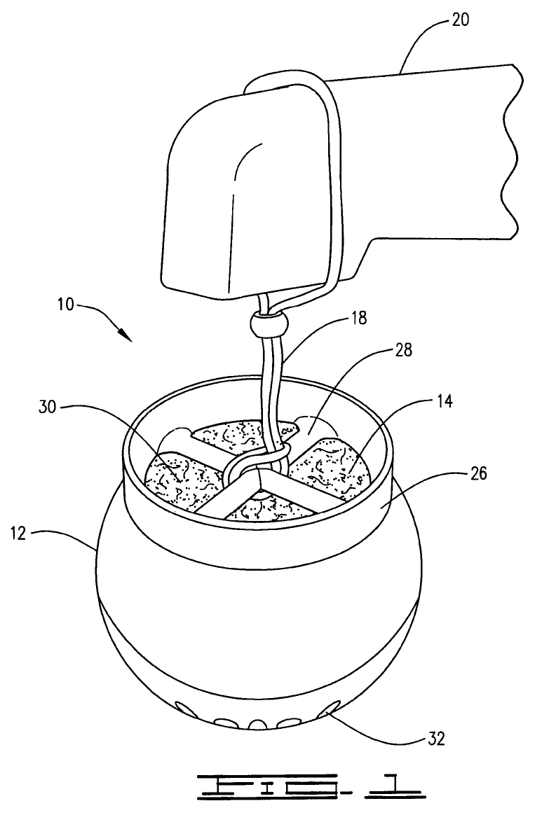

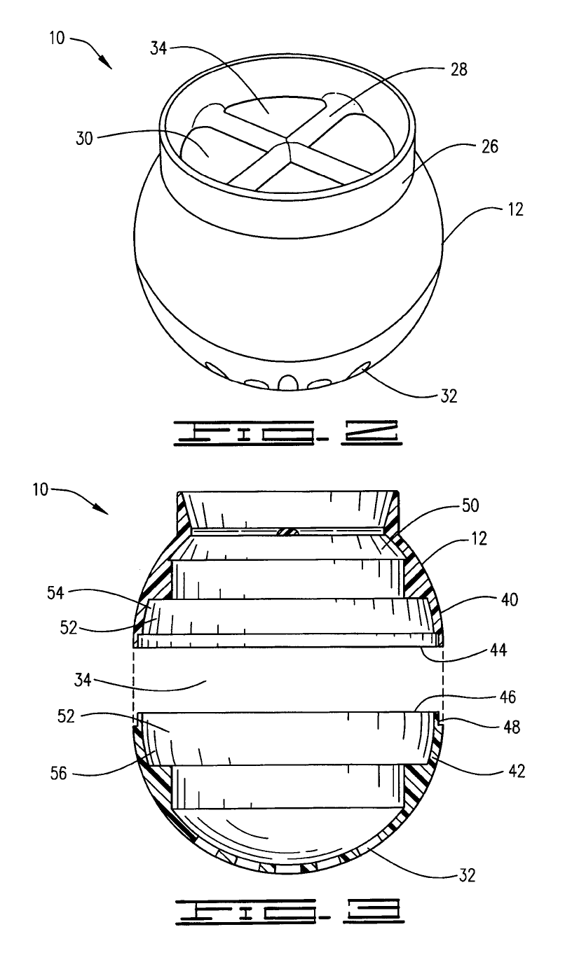

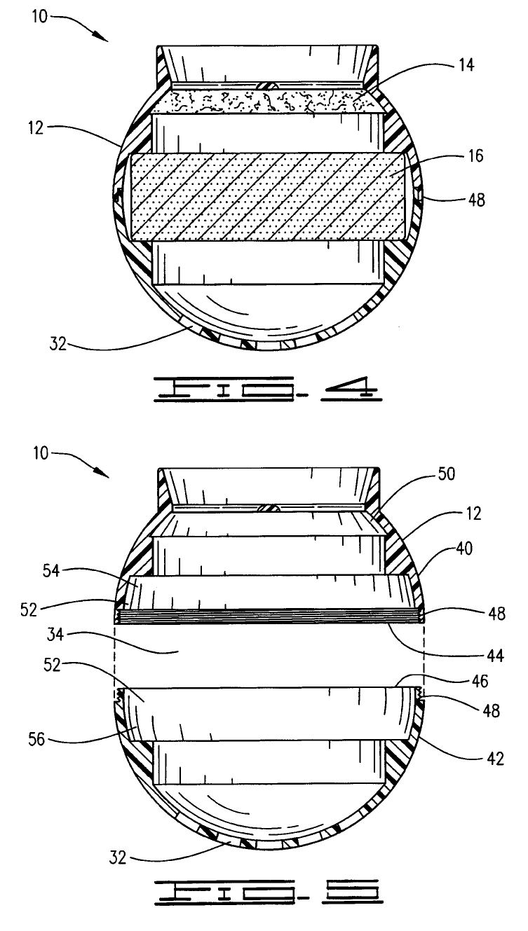

Referring now to the drawings, and particularly to FIGS. 1-2, shown therein is a pictorial representation of the filtering apparatus 10 of the present invention. The filtering apparatus 10 is provided with a housing 12, a first filter 14, a second filter 16 (the second filter 16 is shown in FIG. 4 and FIG. 6), and a connecting element 18 which connects the filtering apparatus 10 to a liquid dispensing source 20.

The housing 12 of the filtering apparatus 10 is shown with a collar 26, at least one support member 28, at least one inlet 30, at least one outlet 32, and an internal chamber 34 extending between the at least one inlet 30 and the at least one outlet 32. The collar 26 extends from the housing 12 such that the collar 26 extends about and surrounds the at least one inlet 30. The collar 26 funnels liquid from the liquid dispensing source 20 into the at least one inlet 30 through the first filter 14 into the internal chamber 34 of the housing 12 and out of the at least one outlet 32. While, the housing 12 of the filtering apparatus 10 is shown with the collar 26, it should be noted that the housing 12 can be provided with or without the collar 26 as long as a liquid is able to be disposed into the internal chamber 34 of the housing 12.

The at least one inlet 30 of the housing 12 is shown with at least one support member 28 extending across at least a portion of the at least one inlet 30 to reinforce the housing 12 and to stabilize and support the first filter 14. The at least one support member 28 is shown configured so as to permit a liquid to pass therethrough into the internal chamber 34 of the housing 12 via the at least one inlet 30. While the housing 12 of the filtering apparatus 10 is depicted as having a substantially spherical shape it should be noted that the housing 12 can be formed of any suitable shape including but not limited to a substantially square, rectangular or triangular shape. Further, the housing 12 of the filtering apparatus 10 can be formed from any suitable material including but not limited to plastic, metal or wood.

The first filter 14 can be formed of any suitable material which is capable of removing particulate matter from a liquid, including but not limited to a substantially fibrous material. The second filter 16 can be formed of any material capable of removing dissolved impurities from a liquid, including but not limited to a reticulated foam media filter. The reticulated foam media filter can be substantially coated with metal particles, including but not limited to copper and zinc particles, metal oxide particles, activated carbon particles and mixtures thereof.

The filtering apparatus 10 is shown connected to a liquid dispensing source 20, such that a liquid can be funneled from the liquid dispensing source 20 by the collar 26 into the at least one inlet 30, through the first filter 14 into the internal chamber 34 of the housing 12, through the second filter 16 and out the at least one outlet 32. The filtering apparatus 10 is shown connected to the liquid dispensing source 20 by the connecting element 18. The connecting element 18 includes any connector or combination of connectors suitable to detachably connect the filtering apparatus 10 to the liquid dispensing source 20 or the like. For example and not by way of limitation, the filtering apparatus 10 can be connected to a liquid dispensing source (such as a kitchen faucet, bath faucet, or outdoor liquid dispensing source) by screw tops, fasteners, string, rope, adhesive, or the like.

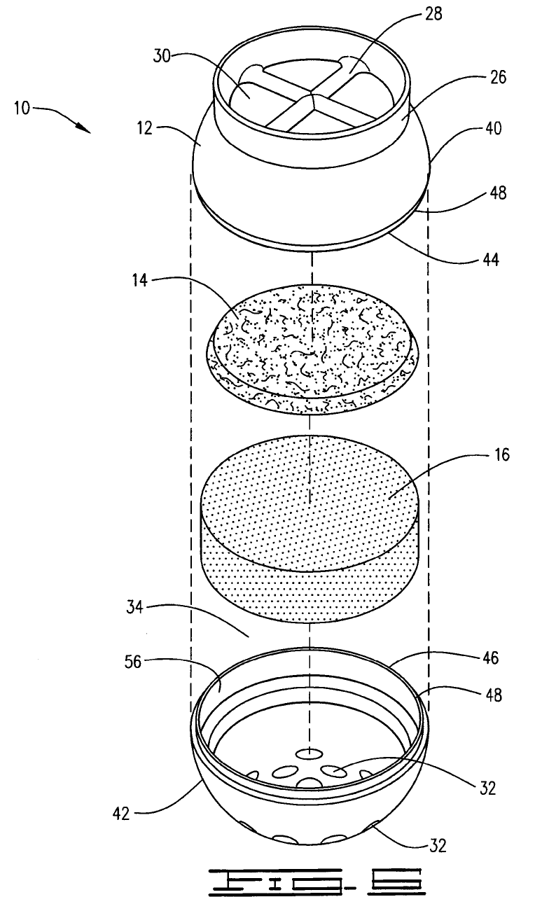

Referring now to FIGS. 3-5, shown therein are cross-sectional pictorial representations of the filtering apparatus 10. Particularly, FIGS. 3-5 depict the housing 12 of the filtering apparatus 10 having an upper portion 40 and a lower portion 42. The upper portion 40 having a lower edge portion 44 and the lower portion 42 having an upper edge portion 46. The upper portion 40 of the housing 12 is shown separated from the lower portion 42 of the housing 12 by a detaching element 48. The detaching element 48 detachably connects the upper portion 40 of the housing 12 to the lower portion 42 of the housing 12 to enhance the replacement of at least one of either the first filter 14 or a second filter 16.

The internal chamber 34 of the housing 12 has a first ledge portion 50 in proximity to the at least one inlet 30. The first ledge portion 50 is positioned to support and stabilize the first filter 14. The internal chamber 34 of the housing 12 also has a second ledge portion 52. The second ledge portion 52 having an upper half 54 positioned in proximity to the lower edge 44 of the upper portion 40 of the housing 12 and a lower half 56 positioned in proximity to the upper edge 46 of the lower portion 42 of the housing 12. The second ledge portion 52 is positioned to support and stabilize the second filter 16.

Referring now to FIG. 6 shown therein is a pictorial representation of the filtering apparatus 10 of the present invention. The filtering apparatus 10 is provided with a housing 12, a first filter 14 and a second filter 16.

Particularly, FIG. 6 depicts the upper portion 40 of the housing 12 separated from the first filter 14, the second filter 16 and the lower portion 42 of the housing 12.

As previously described, the housing 12 of the filtering apparatus 10 is shown with a collar 26, at least one support member 28, at least one inlet 30, at least one outlet 32, and an internal chamber 34 extending between the at least one inlet 30 and the at least one outlet 32. The collar 26 extends from the housing 12 such that the collar 26 extends about and surrounds the at least one inlet 30. The collar 26 funnels liquid from the liquid dispensing source 20 into the at least one inlet 30 through the first filter 14 into the internal chamber 34 of the housing 12 and out of the at least one outlet 32.

The at least one inlet 30 of the housing 12 is shown with at least one support member 28 extending across at least a portion of the at least one inlet 30 to reinforce the housing 12 and to stabilize and support the first filter 14.

The at least one support member 28 is shown configured so as to permit a liquid to pass therethrough into the internal chamber 34 of the housing 12 via the at least one inlet 30.

What is claimed is:

1. A filtering apparatus comprising:
a housing having at least one inlet, at least one outlet, and an internal chamber extending therebetween such that the at least one inlet and the at least one outlet are in fluid communication via the internal chamber of the housing;
a first filter disposed in the internal chamber of the housing so as to be in proximity to the at least one inlet, the first filter capable of removing particulate matter from a liquid entering the internal chamber of the housing via the inlet thereof; and
a second filter disposed in the internal chamber of the housing in proximity to the at least one outlet, the second filter capable of removing dissolved impurities from the liquid entering the internal chamber of the housing via the inlet thereof.

2. The filtering apparatus of claim 1 wherein the first filter is a substantially fibrous filter.

3. The filtering apparatus of claim 2 wherein the second filter is a reticulated foam media filter capable of removing dissolved impurities.

4. The filtering apparatus of claim 2 wherein the second filter is a reticulated foam media filter substantially coated with metal particles.

5. The filtering apparatus of claim 2 wherein the second filter is a reticulated foam media filter consisting of metal particles, metal oxide particles, activated carbon particles, and mixtures thereof.

6. The filtering apparatus of claim 2 wherein the second filter is a reticulated foam media filter substantially coated with a stable mixture of activated carbon, copper and zinc particles.

7. The filtering apparatus of claim 1 wherein the at least one inlet has at least one support member extending across at least a portion of the at least one inlet to reinforce the housing surrounding the at least one inlet and to stabilize the first filter, the at least one support member configured to permit liquid to pass therethrough into the internal chamber of the housing via the at least one inlet.

8. The filtering apparatus of claim 1 wherein the housing is substantially spherical.

9. The filtering apparatus of claim 1 wherein the housing has a plurality of outlets.

10. The filtering apparatus of claim 1 wherein the housing has a plurality of inlets.

11. The filtering apparatus of claim 1 wherein the second filter is spatially disposed from the first filter in the internal chamber of of the housing and wherein the housing has an upper portion having a lower edge and a lower portion having an upper edge.

12. The filtering apparatus of claim 11 wherein the upper portion of the housing can be selectively connected to the lower portion of the housing by a detaching element which detachably connects the upper portion of the housing to the lower portion of the housing to enhance the replacement of at least one of the first or second filters.

13. The filtering apparatus of claim 12 wherein the internal chamber of the housing has a first ledge portion in proximity to the at least one inlet, the first ledge portion positioned to support and stabilize the first filter.

14. The filtering apparatus of claim 13 wherein the internal chamber of the housing has a second ledge portion, the second ledge portion having an upper half positioned in proximity to the lower edge of the upper portion of the housing and a lower half positioned in proximity to the upper edge of the lower portion of the housing, the second ledge portion positioned to support and stabilize the second filter.

15. A filtering apparatus comprising:
a housing having at least one inlet, at least one outlet, and an internal chamber extending therebetween such that the at least one inlet and the at least one outlet are in fluid communication via the internal chamber of the housing;
a collar connected to the housing such that the collar extends about the at least one inlet and extends a distance from an outer periphery of the housing, the collar surrounding the at least one inlet;
a first filter disposed In the Internal chamber of the housing so as to be in proximity to the at least one inlet, the first filter capable of removing particulate matter from a liquid entering the internal chamber of the housing via the inlet thereof; and
a second filter disposed in the internal chamber of the housing in proximity to the at least one outlet, the second filter capable of removing dissolved impurities from the liquid entering the internal chamber of the housing via the inlet thereof.

16. The filtering apparatus of claim 15 wherein the first filter is a substantially fibrous filter.

17. The filtering apparatus of claim 15 wherein the second filter is a reticulated foam media filter.

18. The filtering apparatus of claim 15 wherein the second filter is a reticulated foam media filter substantially coated with metal particles.

19. The filtering apparatus of claim 15 wherein the second filter is a reticulated foam media filter consisting of metal particles, metal oxide particles, activated carbon particles, and mixtures thereof.

20. The filtering apparatus of claim 15 wherein the second filter is a reticulated foam media filter substantially coated with a stable mixture of activated carbon, copper and zinc particles.

21. The filtering apparatus of claim 15 wherein the at least one inlet has at least one support member extending across at least a portion of the at least one inlet to reinforce the housing surrounding the at least one inlet and to stabilize the first filter, the at least one support member configured to permit liquid to pass therethrough into the internal chamber of the housing via the at least one inlet.

22. The filtering apparatus of claim 15 wherein the housing is substantially spherical.

23. The filtering apparatus of claim 15 wherein the housing has a plurality of outlets.

24. The filtering apparatus of claim 15 wherein the housing has a plurality of inlets.

25. The filtering apparatus of claim 15 wherein the second filter is spatially disposed from the first filter in the Internal chamber of the housing and wherein the housing has an upper portion having a lower edge and a lower portion having an upper edge.

26. The filtering apparatus of claim 25 wherein the upper portion of the housing can be selectively connected to the lower portion of the housing by detachably connecting the upper portion of the housing to the lower portion of the housing to enhance the replacement of at least one of the first or second filters.

27. The filtering apparatus of claim 25 wherein the internal chamber of the housing has a first ledge portion in proximity to the at least one inlet, the first ledge portion positioned to support and stabilize the first filter.

28. The filtering apparatus of claim 27 wherein the internal chamber of the housing has a second ledge portion, the second ledge portion having an upper half positioned in proximity to the lower edge of the upper portion of the housing and a lower half positioned in proximity to the upper edge of the lower portion of the housing, the second ledge portion positioned to support and stabilize the second filter.

29. A method of filtering a liquid, the method comprising the steps of:
providing a filtering apparatus having;
a housing having at least one inlet, at least one outlet, and an internal chamber extending therebetween such that the at least one inlet and the at least one outlet are in fluid communication via the internal chamber of the housing;
a first filter disposed in the internal chamber of the housing so as to be in proximity to the at least one inlet, the first filter capable of removing particulate matter from a liquid entering the internal chamber of the housing via the inlet thereof;
a second filter disposed in the internal chamber of the housing in proximity to the at least one outlet, the second filter capable of removing dissolved impurities from the liquid entering the internal chamber of the housing via the inlet thereof;
connecting the filtering apparatus to a liquid dispensing source; and
passing a liquid through the filtering apparatus such that the liquid passes through the at least one inlet into the internal chamber of the housing, through the first filter, through the second filter and out the at least one outlet.

30. The method of claim 29 wherein the first filter is a substantially fibrous filter.

31. The filtering method of claim 29 wherein the second filter is a reticulated foam media filter.

32. The method of claim 29 wherein the second filter is a reticulated foam media filter substantially coated with metal particles.

33. The method of claim 29 wherein the second filter is a reticulated foam media filter consisting of metal particles, metal oxide particles, activated carbon particles, and mixtures thereof.

34. The method of claim 29 wherein the second filter is a reticulated foam media filter substantially coated with a stable mixture of activated carbon, copper and zinc particles.

35. The method of claim 29 wherein the at least one inlet has at least one support member extending across at least a portion of the at least one inlet to reinforce the housing surrounding the at least one inlet and to stabilize the first filter, the at least one support member configured to permit liquid to pass therethrough into the internal chamber of the housing via the at least one inlet.

36. The method of claim 29 wherein the housing is substantially spherical.

37. The method of claim 29 wherein the housing has a plurality of outlets.

38. The method of claim 29 wherein the housing has a plurality of inlets.

39. The method of claim 29 wherein the second filter is spatially disposed from the first filter in the internal chamber of the housing and wherein the housing has an upper portion having a lower edge and a lower portion having an upper edge.

40. The method of claim 39 wherein the upper portion of the housing can be selectively connected to the lower portion of the housing by detachably connecting the upper portion of the housing to the lower portion of the housing to enhance the replacement of at least one of the first or second filters.

41. The method of claim 39 wherein the internal chamber of the housing has a first ledge portion in proximity to the at least one inlet, the first ledge portion positioned to support and stabilize the first filter.

42. The method of claim 39 wherein the internal chamber of the housing has a second ledge portion, the second ledge portion having an upper half positioned in proximity to the lower edge of the upper portion of the housing and a lower half positioned in proximity to the upper edge of the lower portion of the housing, the second ledge portion positioned to support and stabilize the second filter.
